(19) United States
(12) Patent Application Publication
(10) Pub. No.: US 2020/0062272 A1
(43) Pub. Date: Feb. 27, 2020

(54) VEHICLE DRIVING CONTROL SYSTEM AND VEHICLE DRIVING CONTROL METHOD

(71) Applicant: ISUZU MOTORS LIMITED, Shinagawa-ku, Tokyo (JP)

(72) Inventor: Koji SUGIURA, Fujisawa-shi, Kanagawa (JP)

(21) Appl. No.: 16/612,625

(22) PCT Filed: May 11, 2018
(86) PCT No.: PCT/JP2018/018243

§ 371 Date: Nov. 11, 2019

(30) Foreign Application Priority Data
May 11, 2017 (JP) 2017-094574

(51) Int. Cl. B60W 50/08; G05D 1/00; B60W 30/18; B60W 40/08

(52) U.S. Cl. CPC B60W 50/08; G05D 1/0088; B60W 2050/0071; B60W 40/08; B60W 30/18

(57) ABSTRACT

Stress tolerance X of a driver of a vehicle is determined in advance. A driver assistance format is selected based on the stress tolerance X of the driver determined in advance when it is necessary to forcibly switch the vehicle from automatic driving to manual driving of the driver. Driver assistance is performed when the vehicle is switched from the automatic driving to the manual driving based on the selected driver assistance format.

### TECHNICAL FIELD

The present disclosure relates to a vehicle driving control system and a vehicle driving control method.

### BACKGROUND ART

In recent years, research and development of techniques for automatically driving a vehicle by a driving control system placed on an automobile, regardless of an operation of a driver, has been carried out (see, for example, PTL 1).

### CITATION LIST

### Patent Literature

PTL 1: JP-A-2016-215658

### SUMMARY OF INVENTION

### Technical Problem

When the vehicle is automatically driven (automatic driving) by the system, there is a possibility that a vehicle driven in front of the given vehicle suddenly decelerates, or stones fall in front of the given vehicle, and the given vehicle may collide with obstacles such as the vehicle ahead or the falling stones. When such a sudden situation occurs, it is necessary to forcibly transfer driving authority of the vehicle from the system to the driver. When the transfer of the driving authority is performed, an alarm is issued, which includes information urging the driver to switch the driving from the automatic driving of the system to manual driving of the driver.

However, in a case where the driver is relatively easy to panic about the sudden situation, in other words, when the driver has low stress tolerance, when the alarm, which gives an excessive sense of urgency, is issued, the driver may panic and it may be difficult to safely and quickly transfer the driving authority of the vehicle from the system to the driver.

An object of the present disclosure is to provide a vehicle driving control system and a vehicle driving control method, which can perform safe and quick transfer when it is necessary to forcibly transfer the vehicle driving authority from the driving control system to the driver.

### Solution to Problem

A vehicle driving control system according to the present disclosure for achieving the above object is a vehicle driving control system which has a function of automatically driving a vehicle. A control device which controls the driving control system includes: a stress tolerance determination unit which determines stress tolerance of a driver of the vehicle; a stress tolerance storage unit which stores the stress tolerance determined by the stress tolerance determination unit; a driving switching determination unit which determines whether it is necessary to forcibly switch to manual driving of the driver during automatic driving of the vehicle; a driver assistance format selection unit which selects a driver assistance format based on the stress tolerance stored in the stress tolerance storage unit when the driving switching determination unit determines that it is necessary to switch from the automatic driving to the manual driving; and a driver assistance execution unit which performs driver assistance when the vehicle is forcibly switched from the automatic driving to the manual driving based on the driver assistance format selected by the driver assistance format selection unit.

A vehicle driving control method according to the present disclosure for achieving the above object is a vehicle driving control method which has a function of automatically driving a vehicle, in which stress tolerance of a driver of the vehicle is determined in advance, and a driver assistance format is selected based on the stress tolerance of the driver determined in advance when it is necessary to forcibly switch the vehicle from automatic driving to manual driving of the driver, and driver assistance is performed when the vehicle is switched from the automatic driving to the manual driving based on the selected driver assistance format.

### Advantageous Effects of Invention

In the present disclosure, when it is necessary to forcibly transfer the vehicle driving authority from the driving control system (control device) to the driver, the driver assistance format (contents) performed by the system when transferring the driving authority, such as volume, frequency, or contents of an alarm containing information which urges the switching from the automatic driving of the system to the manual driving of the driver, is set based on the stress tolerance of the driver.

Accordingly, a driver having low stress tolerance can be prevented from falling into a panic due to reception of an alarm which gives an excessive sense of urgency. As a result, the vehicle driving authority can be safely and quickly transferred when it is necessary to forcibly transfer the vehicle driving authority from the driving control system to the driver.

### BRIEF DESCRIPTION OF DRAWINGS

FIG. 1 shows a configuration of a vehicle driving control system according to the present disclosure.

FIG. 2 shows timing of start of issuing driving switching alarm and start of automatic braking based on a distance between a given vehicle and a vehicle ahead. Section (a) of FIG. 2 shows a state where the given vehicle is driven automatically. Section (b) of FIG. 2 shows the timing of the start of issuing the driving switching alarm of the given vehicle. Section (c) of FIG. 2 shows the timing of the start of the automatic braking of the given vehicle.

FIG. 3 shows a control flow of a vehicle driving control method according to the present disclosure.

### DESCRIPTION OF EMBODIMENTS

Hereinafter, a vehicle driving control system and a vehicle driving control method according to the present disclosure will be described based on an embodiment shown in the drawings. A vehicle 3 including a vehicle driving control system 1 according to the present disclosure has an automatic driving function that allows the driving control system 1 to automatically drive the vehicle 3 without following a driving operation of a driver. That is, the automatic driving function is a function in which the driving control system 1, instead of the driver, performs a vehicle speed control operation (depressing an accelerator pedal or a brake pedal) and a steering control operation (handle operation). Therefore, either the driver or the driving control system 1 has driving authority for the vehicle 3. The vehicle 3 is provided with a control device 2 that controls the driving control system 1.

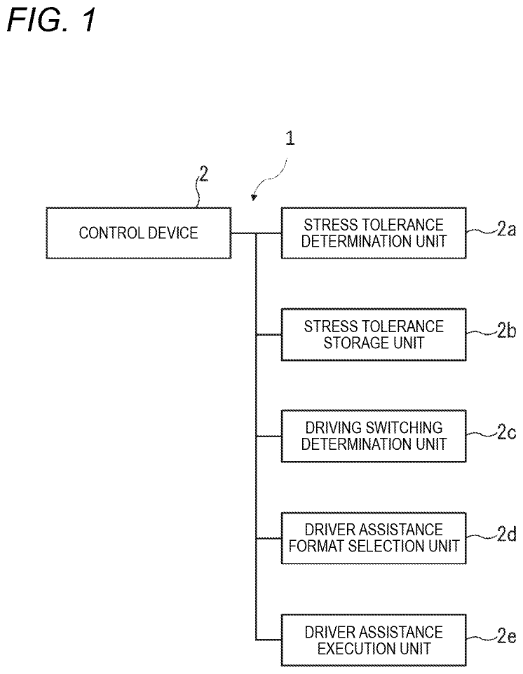

In the present disclosure, as shown in FIG. 1, the control device 2 includes five units: a stress tolerance determination unit 2a; a stress tolerance storage unit 2b; a driving switching determination unit 2c; a driver assistance format selection unit 2d; and a driver assistance execution unit 2e.

The stress tolerance determination unit 2a is a unit which measures and detennines stress tolerance X of the driver of the vehicle 3. The stress tolerance of the driver refers to an index indicating how easily the driver is likely to panic, regardless of physical conditions, due to sudden situations such as sudden danger that the given vehicle 3 collides with an obstacle such as a vehicle driven ahead.

For example, the stress tolerance determination unit 2a measures and determines the stress tolerance X based on a heart rate of the driver detected by a heart rate measurement sensor or the like provided in a driver seat of the vehicle 3. More specifically, the stress tolerance X is measured based on a degree of increase in the heart rate ΔHR of the driver when the driver manually drives the vehicle and suddenly brakes or turns a steering wheel, as compared with a normal heart rate of the driver during driving. When the stress tolerance X is the same value as the degree of increase in the heart rate ΔHR (X=ΔHR), the control may be simplified. By comparing the measured stress tolerance X with a preset threshold value, it is determined whether the stress tolerance X of the driver is high or low. As the degree of increase in the heart rate ΔHR increases, the stress tolerance X of the driver is determined to be lower. A determination result of the stress tolerance X may have two levels including high or low, three levels including high, normal, or low, or four or more levels. The measurement of the stress tolerance X based on the heart rate may be performed only once, however it is more preferable that the determination of the stress tolerance X is performed a plurality of times and an average value of measurement results of the plurality of times is used, so that accuracy of the determination of the stress tolerance X of the driver can be improved.

The stress tolerance determination unit 2a may store a plurality of questions related to driver characteristics in advance in the stress tolerance determination unit 2a, and measure and determine the stress tolerance X of the driver based on answers of the driver to questions extracted from the stored plurality of questions. The questions to the driver are in the form of multiple choice questions, and are given by voice from a voice device provided in the driver seat when starting the vehicle or during steady running, or by text displayed on a text display panel. The answers of the driver to the questions are made verbally or by operating a handle switch. Since there are cases when it is difficult for the driver to answer the questions due to a need to perform a sudden driving operation, the questions are canceled when a preset control time (for example, about 30 seconds to 1 minute) has elapsed since a time point when the questions were given without obtaining the answers from the driver. Since control for obtaining the answers to the questions is performed while the driving operation of the driver is prioritized in this way, an answering speed of the driver to the question does not affect the measurement and determination of the stress tolerance X of the driver. The number of the questions for the driver may be one, however it is more preferable that a plurality of questions are given, so that the accuracy of the determination of the stress tolerance X can be improved.

A numerical value is set for each choice of the question, and the stress tolerance X is measured based on a total value AC of numerical values of choices answered by the driver. When the stress tolerance X is the same value as the numerical value AC based on the answered contents of the driver (X=AC), the control may be simplified. By comparing the measured stress tolerance X with a preset threshold value, it is determined whether the stress tolerance X of the driver is high or low. As the total value AC increases, the stress tolerance X of the driver is determined to be lower. As in the case of the determination of the stress tolerance X based on the heart rate, the determination result of the stress tolerance X may have two levels, three levels or four or more levels.

The stress tolerance determination unit 2a may measure and determine the stress tolerance X by using both the degree of increase of the heart rate ΔHR and the numerical value AC based on the answered contents. In this case, the stress tolerance X is calculated (measured) using, for example, a linear calculation formula of X=α×ΔHR+β×AC, where a and are weighting coefficients. Magnitudes of the weighting coefficients α and β are preferably determined based on experimentally verified results.

As described above, the stress tolerance determination unit 2a is configured as a unit which determines the stress tolerance of the driver based on the heart rate of the driver or the answers to the questions given from the stress tolerance determination unit 2a to the driver, so that the stress tolerance X of the driver can be measured and determined with high accuracy.

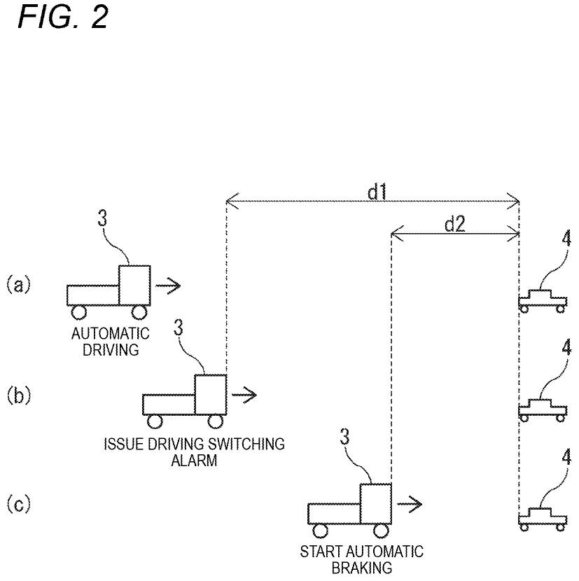

The stress tolerance storage unit 2b is a unit which stores the stress tolerance X determined by the stress tolerance determination unit 2a. The driving switching determination unit 2c is a unit which determines whether it is necessary to forcibly switch to manual driving of the driver when the vehicle 3 is automatically driven by the driving control system 1, as shown in FIG. 2(a), that is, a unit which determines whether it is necessary to forcibly transfer the driving authority of the vehicle 3 from the driving control system 1 to the driver.

More specifically, the driving switching determination unit 2c determines whether it is necessary to switch a driving mode of the vehicle 3 from the automatic driving to the manual driving when a collision allowance time t before the given vehicle 3 collides with an obstacle 4 located in front of the given vehicle 3 is equal to or less than a preset time threshold value t1 during the automatic driving of the given vehicle 3 or, as shown in FIG. 2(b), when a distance d between the given vehicle 3 and the obstacle 4 is equal to or less than a preset distance threshold value d1 which is preset according to a speed of the given vehicle 3 (vehicle speed) so as to avoid collision between the given vehicle 3 and the obstacle 4 which may happen if the automatic driving of the given vehicle 3 is continued. The distance d is detected by using radar or a camera for detecting an inter-vehicle distance placed on the given vehicle 3. A relative speed of the given vehicle 3 with respect to the obstacle 4 is calculated from a continuous change in a detected value of the distance d, and the collision allowance time t is calculated by using the calculated value of the relative speed and the detected value of the distance d. The obstacle 4 is, for example, a vehicle driven in front of a driving lane on which the given vehicle 3 is driven or a falling stone provided in front of the driving lane on which the given vehicle 3 is driven due to occurrence of landslide in front of the given vehicle 3.

In this way, by determining whether it is necessary to forcibly transfer the driving authority of the vehicle 3 from the driving control system 1 to the driver according to the collision allowance time t or the distance d, it is determined that the driving authority is necessary to be transferred only when there is a possibility that the given vehicle 3 may collide with the obstacle 4, so that an increase in unnecessary driving burden on the driver can be prevented.

The driver assistance format selection unit 2d is a unit which selects a driver assistance format based on the stress tolerance X stored in the stress tolerance storage unit 2b when the driving switching determination unit 2c determines that it is necessary to switch from the automatic driving to the manual driving. The driver assistance format selection unit 2d stores a driver assistance format stored in advance based on the stress tolerance X.

The driver assistance format is a format which provides information configured to urge the manual driving of the driver. More specifically, the driver assistance format is a format of volume, frequency, or contents of an alarm containing the information which urges the switching from the automatic driving of the driving control system 1 to the manual driving of the driver. For example, in a case where the determination of the stress tolerance X has two levels including high or low, when the stress tolerance X of the driver is high, the volume of the alarm is set to be high and the frequency is set to be high to give an appropriate sense of urgency to the driver, and the format is set to only notify the driver that it is necessary to switch from the automatic driving to the manual driving, such as “please switch from automatic driving to manual driving” without instructing detailed driving operations. A format of the alarm for the driver having high stress tolerance X is preferably set to have a volume, frequency, or content format that is comparable to an alarm that has been conventionally given to the driver. Meanwhile, when the determination of the stress tolerance X of the driver is low, as compared with the alarm issued to the driver who has high stress tolerance X, the volume of the alarm is set to be low and the frequency is set to be low so as not to give an excessive sense of urgency to the driver, and the format is set to instruct the driver to perform detailed driving operations such as “please step on the brake pedal” or “please steer to the right to change the driving lane”.

In a case where the determination of the stress tolerance X has three or more levels, when the stress tolerance X is low, the volume of the alarm and the frequency are set to be low, information is communicated to the driver in a soft expression, and the contents of the information is simplified. In this case, when the stress tolerance X is of the highest level, the format of the alarm is also preferably set to have the volume, frequency, or content format that is comparable to the alarm that has been conventionally given to the driver.

By selecting the driver assistance format in this way, information necessary for switching from the automatic driving of the driving control system 1 to the manual driving of the driver can be reliably transmitted to the driver without causing a panic.

The driver assistance execution unit 2e is a unit which performs driver assistance when the vehicle 3 is forcibly switched from the automatic driving to the manual driving based on the driver assistance format selected by the driver assistance format selection unit 2d. For example, the voice device, or the text display panel provided in the driver seat corresponds to the unit 2e. After the driving switching determination unit 2c determines that it is necessary to switch the vehicle 3 from the automatic driving to the manual driving, and the driver assistance format is selected by the driver assistance format selection unit 2d based on the stress tolerance X of the driver, an alarm corresponding to the driver assistance format selected by the driver assistance format selection unit 2d is issued by the driver assistance execution unit 2e.

As described above, according to the present disclosure, the driver having low stress tolerance can be prevented from falling into a panic due to reception of an alarm which gives an excessive sense of urgency. As a result, the vehicle driving authority can be safely and quickly transferred when it is necessary to forcibly transfer the driving authority of the vehicle 3 from the driving control system 1 to the driver.

When the driver performs a sudden braking or a sudden steering while the driver assistance execution unit 2e is issuing the alarm, the driving authority of the vehicle 3 is completely switched from the driving control system 1 to the driver. Determination of whether the driver has performed the sudden braking is made based on whether an amount of decrease per unit time of an acceleration sensor placed on the vehicle 3 is larger than a preset decrease amount. Determination of whether the driver has performed the sudden steering is made based on whether an amount of fluctuation per unit time of a steering angle sensor placed on the vehicle 3 is larger than a preset fluctuation amount.

The vehicle 3 may be gradually decelerated or the steering angle may be gradually adjusted by the driving control system 1 until the driver operates in response to the alarm since a start of the issuing of the alarm of the driver assistance execution unit 2e. By performing control in this way, the driver can know the driving operation necessary for switching from the automatic driving to the manual driving physically.

While the driver assistance execution unit 2e is issuing the alarm, when the collision allowance time t before the given vehicle 3 collides with the obstacle 4 is equal to or less than a preset second time threshold value t2, which is a value smaller than the time threshold value t1, or as shown in FIG. 2(c), when the distance d between the given vehicle 3 and the obstacle 4 is equal to or less than a preset second distance threshold value d2, which is a value smaller than the distance threshold value d1, the driving control system 1 forcibly starts automatic braking for stopping the given vehicle 3 before the obstacle 4 regardless of the operation of the driver.

In this way, even if the driver takes time for the driving operation, the given vehicle 3 is forcibly automatically stopped before the obstacle 4 so that the collision between the given vehicle 3 and the obstacle 4 can be avoided.

When landslide suddenly occurs in front of the vehicle and the falling stone 4 is provided in front of a driving lane on which the given vehicle 3 is driven during automatic driving of the vehicle, in a case where the distance d between the given vehicle 3 and the falling stone 4 is less than a distance threshold d2, the driving control system 1 starts the automatic braking for forcibly stopping the given vehicle 3 before the falling stone 4 without urging the driver to switch from the automatic driving of the vehicle to the manual driving. In this way, the collision between the given vehicle 3 and the obstacle 4 can be avoided without giving an excessive driving burden to the driver.

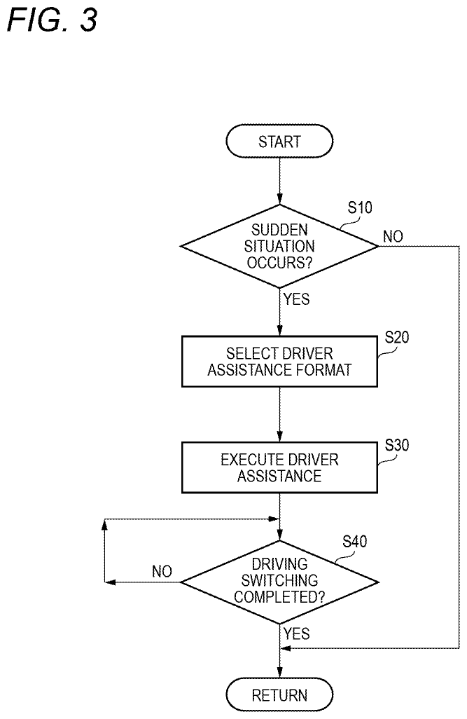

Next, a vehicle driving control method according to the present disclosure based on the vehicle driving control system 1 will be described with reference to a control flow of FIG. 3. The control flow of FIG. 3 is a control flow executed from a preceding control flow each time a preset control time elapses during the automatic traveling of the vehicle. When the control flow of FIG. 3 is started, in step S10, it is determined whether a sudden situation has occurred, such as sudden deceleration of the vehicle 4 traveling in front of the driving lane on which the given vehicle 3 is driven. If the sudden situation does not occur (NO), the process returns, and the control flow is ended. Meanwhile, if the sudden situation occurs (YES), the process proceeds to step S20, and the driver assistance format is selected based on the stress tolerance X stored in advance in the stress tolerance storage unit 2b in step S20. After the control of step S20 is performed, the process proceeds to step S30.

In step S30, based on the driver assistance format selected in step S20, the driver assistance necessary for forcibly switching the given vehicle 3 from the automatic driving to the manual driving is performed, and the driving authority of the given vehicle 3 is transferred from the driving control system 1 to the driver. After the control of step S30 is performed, the process proceeds to step S40.

In step S40, the driver performs sudden braking or sudden steering to determine whether the driving switching of the own vehicle 3 from the automatic driving of the driving control system 1 to the manual driving of the driver is completed. If the driving switching is not completed (NO), the determination in step S40 is performed again after the preset control time has elapsed. Meanwhile, when the driving switching is completed (YES), the process returns, and the control flow is ended.

As described above, the vehicle driving control method based on the vehicle driving control system 1 of the present disclosure is a vehicle driving control method which has a function of automatically driving the vehicle, in which the stress tolerance X of the driver of the vehicle 3 is determined in advance, and the driver assistance format is selected based on the stress tolerance X of the driver determined in advance when it is necessary to forcibly switch the vehicle 3 from the automatic driving to the manual driving of the driver, and the driver assistance is performed when the vehicle 3 is switched from the automatic driving to the manual driving based on the selected driver assistance format.

According to this method, the same effect as those of the vehicle driving control system 1 can be obtained.

In the present embodiment, although it is assumed that the stress tolerance X of the driver is stored in advance in the stress tolerance storage unit 2b, in a case where the stress tolerance storage unit 2b does not store the stress tolerance X of the driver, that is, in a case where the stress tolerance X of the driver is not determined by the stress tolerance determination unit 2a, it is assumed that the stress tolerance X of the driver is low, and the driver assistance is performed based on the driver assistance format selected when the stress tolerance X is low. In this way, safety of the transfer of the driving authority of the vehicle from the driving control system 1 to the driver can be ensured.

When there are a plurality of drivers, instead of on driver, who may drive the vehicle 3, the stress tolerance storage unit 2b stores the stress tolerance of each driver, and when it is necessary to transfer the driving authority of the vehicle 3 from the driving control system 1 to the driver, the driver assistance format selection unit 2d selects the driver assistance format based on the stress tolerance of each driver stored in the stress tolerance storage unit 2b. Distinguishing between the drivers of the vehicle 3 may be performed based on, for example, distribution of the weight of the driver applied to a seat surface of the driver seat when the driver sits on the driver seat, or may use a method of detecting and authenticating a face using a camera placed in the vehicle, or to distinguish by inserting an employee ID or the like, in which a license or personal information is registered, into a card reader.

In the above description, attention is paid to the control device 2 provided in the driving control system 1, and the function realized by the control device 2 is described by being divided into the five units, namely, the stress tolerance determination unit 2a, the stress tolerance storage unit 2b, the driving switching determination unit 2c, the driver assistance format selection unit 2d, and the driver assistance execution unit 2e.

Specifically, the control device 2 may be implemented, for example, by the following configuration. That is, the control device 2 is connected to various devices provided in the vehicle 3 by wireless or wired connection, and can be configured to include an interface which transmits and receives a signal configured to communicate with the various devices, a memory which stores information, and a controller.

The various devices include, for example: an operation unit such as a button, a switch, and a touch panel operated by the driver or an occupant of the vehicle 3; a display which displays a screen; a speaker which outputs voice; a microphone which receives voice commands from the driver or the occupant; a heart rate measurement sensor which measures a heart rate of the driver; an in-vehicle camera which images and monitors a driving state of the driver, and the like.

The various devices include, for example: various actuators configured to control the driving state of the vehicle 3; a brake system of the vehicle 3; an engine control system of the vehicle 3; a lighting device provided in the vehicle 3, such as a light, a rear lamp and a hazard lamp; a vehicle speed sensor which measures the vehicle speed of the vehicle 3; an acceleration sensor or an impact sensor which measures acceleration or impact occurring in the vehicle 3; a steering angle sensor which measures a steering angle of the vehicle 3; a driving camera or radar which detects a driving environment of the vehicle 3, and the like.

The interface includes a communication module configured to communicate with the various devices, and may be connected to the various devices by wired connection, for example, by including a connector, or may be wirelessly connected to the various devices, for example, by including a wireless communication module.

The memory may include a semiconductor storage device such as a rewritable DRAM or EPROM, or a non-rewritable ROM, or may include a storage device such as a hard disk.

The controller is connected to the interface and the memory. The controller may be configured, for example, by a processor, and may be configured to execute a series of processing by executing a program stored in the memory, or may be configured as hardware such as an ASIC and configured to execute a predetermined series of processing.

The controller determines the stress tolerance of the driver of the vehicle 3 based on the signal transmitted and received by the interface, stores, in the memory, a stress tolerance value showing a level of the determined stress tolerance, determines, based on the signal transmitted and received by the interface, whether it is necessary to forcibly switch to the manual driving of the driver during the automatic driving of the vehicle 3, selects the driver assistance format corresponding to the stress tolerance value stored in the memory from a plurality of driver assistance formats registered in advance, in response to determination that it is necessary to forcibly switch from the automatic driving to the manual driving, and performs the driver assistance when the vehicle 3 is forcibly switched from the automatic driving to the manual driving by controlling the devices via the interface based on the selected driver assistance format.

This application is based on JP-A-2017-094574 filed on May 11, 2017, the contents of which are incorporated herein by reference.

### INDUSTRIAL APPLICABILITY

According to the present disclosure, a driver having low stress tolerance can be prevented from falling into a panic due to reception of an alarm which gives an excessive sense of urgency, and vehicle driving authority can be safely and quickly transferred when it is necessary to forcibly transfer the vehicle driving authority from the driving control system to the driver.

### REFERENCE SIGNS LIST

1 Vehicle driving control system
2 Control device
2a Stress tolerance determination unit
2b Stress tolerance storage unit
2c Driving switching determination unit
2d Driver assistance format selection unit
2e Driver assistance execution unit
3 Vehicle and given vehicle
4 Falling stone and vehicle ahead (obstacle)
X Stress tolerance
ΔHR Degree of increase of heart rate of driver
AC Numerical value based on answered contents of driver

1. A vehicle driving control system which has a function of automatically driving a vehicle, wherein
a control device which controls the driving control system includes:
a stress tolerance determination unit which determines stress tolerance of a driver of the vehicle;
a stress tolerance storage unit which stores the stress tolerance determined by the stress tolerance determination unit;
a driving switching determination unit which determines whether it is necessary to forcibly switch to manual driving of the driver during automatic driving of the vehicle;
a driver assistance format selection unit which selects a driver assistance format based on the stress tolerance stored in the stress tolerance storage unit when the driving switching determination unit determines that it is necessary to switch from the automatic driving to the manual driving; and
a driver assistance execution unit which performs driver assistance when the vehicle is forcibly switched from the automatic driving to the manual driving based on the driver assistance format selected by the driver assistance format selection unit.

2. The vehicle driving control system according to claim 1, wherein the stress tolerance determination unit is a unit which determines the stress tolerance of the driver based on a heart rate of the driver or an answer to a question given from the stress tolerance determination unit to the driver.

3. The vehicle driving control system according to claim 1, wherein the driving switching determination unit is a unit which determines whether it is necessary to switch the vehicle from the automatic driving to the manual driving when a collision allowance time before the vehicle collides with an obstacle located in front of the vehicle is equal to or less than a preset time threshold value or when a distance between the vehicle and the obstacle is equal to or less than a preset distance threshold value which is preset according to a speed of the vehicle.

4. The vehicle driving control system according to claim 1, wherein the driver assistance format is a format which provides information configured to urge the manual driving of the driver.

5. A vehicle driving control method which has a function of automatically driving a vehicle comprising:
determining stress tolerance of a driver of the vehicle in advance;
selecting a driver assistance format based on the stress tolerance of the driver determined in advance when it is necessary to forcibly switch the vehicle from automatic driving to manual driving of the driver; and
performing driver assistance when the vehicle is switched from the automatic driving to the manual driving based on the selected driver assistance format.

6. A vehicle driving control system which automatically drives a vehicle, comprising:
an interface which is connected to a device provided in the vehicle by wireless or wired connection, and transmits and receives a signal configured to communicate with the device;
a memory which stores information; and
a controller which
determines stress tolerance of a driver of the vehicle based on the signal transmitted and received by the interface,
stores, in the memory, a stress tolerance value showing a level of the determined stress tolerance,
determines, based on the signal transmitted and received by the interface, whether it is necessary to forcibly switch to manual driving of the driver during automatic driving of the vehicle,
selects a driver assistance format corresponding to the stress tolerance value stored in the memory from a plurality of driver assistance formats registered in advance, in response to determination that it is necessary to forcibly switch from the automatic driving to the manual driving, and
performs driver assistance when the vehicle is forcibly switched from the automatic driving to the manual driving by controlling the device via the interface based on the selected driver assistance format.
